(19) United States
(12) Patent Application Publication
(10) Pub. No.: US 2019/0162239 A1
(43) Pub. Date: May 30, 2019

(54) TOOTHED SHAFT, METHOD FOR PRODUCING SAME, AND METHOD FOR PRODUCING A FUNCTIONAL SHAFT

(71) Applicants: THYSSENKRUPP PRESTA TECCENTER AG, Eschen (LI); thyssenkrupp AG, Essen (DE)

(72) Inventors: Manfred MUSTER, Ludesch (AT); Marko CURLIC, Schaanwald (LI); Aaron PFITSCHER, Ludesch (AT)

(73) Assignees: THYSSENKRUPP PRESTA TECCENTER AG, Eschen (LI); thyssenkrupp AG, Essen (DE)

(21) Appl. No.: 16/308,512

(22) PCT Filed: Jun. 16, 2017
(86) PCT No.: PCT/EP2017/064776

§ 371 Date: Dec. 10, 2018

(30) Foreign Application Priority Data
Jun. 16, 2016 (DE) 10 2016 111 029.9

(51) Int. Cl. F16D 1/10

(52) U.S. Cl. CPC F16D 1/101; F16D 2001/103

(57) ABSTRACT

A toothed shaft having a toothed portion, in which tooth arrangements are formed on the cover of the toothed shaft and extend parallel with a rotation axis of the toothed shaft. An assembly portion has tooth arrangements adjoining the toothed portion. The number and the radial position of the tooth arrangements in the assembly portion correspond to the number and the radial position of the tooth arrangements in the toothed portion. At least one tooth thickness of the tooth arrangements is greater in the assembly portion than a tooth thickness in the toothed portion, or at least one root circle diameter of the tooth arrangements in the assembly portion is greater than the root circle diameter in the toothed portion, or at least one tip circle diameter of the tooth arrangements in the assembly portion is greater than the tip circle diameter in the toothed portion.

The invention relates to a toothed shaft according to patent claim 1, a method for the production thereof according to patent claim 6 and a method for producing a functional shaft according to patent claim 11.

During the production of shafts for different applications, it is necessary to mount functional elements, such as cams or sensor rings, securely on the shaft. Particularly during the assembly of cams on the shaft, the axial position and relative angular orientation thereof must be able to be determined precisely in this case. Particularly in the case of cams, it must further be ensured that the cams cannot be rotated counter to the shaft after the assembly.

Therefore, camshafts are often cast in one piece from cast iron. In this case, however, it is disadvantageous that these shafts have a high weight and the flexibility in selecting the cam material and the cam position and geometry is very limited.

Therefore, constructed camshafts in which the cams and other functional elements are fixed on a prefabricated shaft are used. This involves the problem mentioned in the introduction of fixing the functional elements to the shaft in such a manner that they are connected to the shaft sufficiently securely and cannot be displaced on the shaft or be rotated counter to the shaft.

In order to solve this problem, various methods have been proposed. For example, WO 2012/031770 A1 discloses a method for assembling a camshaft in which cam elements having a hole are fitted on a shaft. It is proposed in this case that the shaft be cooled or the elements to be positioned be heated in order to make it easier to push the elements onto the shaft as a result of the material contraction or expansion because of the temperature. During the subsequent heating of the shaft or cooling of the fitted elements, a press-fit is then achieved.

However, the known method is disadvantageous in several regards. Firstly, the method is time-consuming as a result of the heating and cooling operations. Secondly, it is difficult to ensure a precise angular orientation of the fitted elements.

Consequently, an object of the invention is to provide a shaft, with which the method of assembling functional elements on the shaft is simplified and with which a high level of rotation prevention of the functional elements on the shaft is provided.

This object is achieved by a toothed shaft according to claim 1, a method for the production thereof according to claim 6 and a method for producing a functional shaft according to claim 11.

The object is achieved in particular by a toothed shaft having a toothed portion, in which tooth arrangements are formed on the cover of the toothed shaft and extend parallel with a rotation axis of the toothed shaft, wherein an assembly portion having tooth arrangements adjoins the toothed portion, wherein the number and the radial position of the tooth arrangements in the assembly portion correspond to the number and the radial position of the tooth arrangements in the toothed portion, and wherein at least one tooth thickness of the tooth arrangements is greater in the assembly portion than a tooth thickness in the toothed portion, or at least one root circle diameter of the tooth arrangements in the assembly portion is greater than the root circle diameter in the toothed portion, or at least one tip circle diameter of the tooth arrangements in the assembly portion is greater than the tip circle diameter in the toothed portion.

An advantage of the invention is that the toothed shaft according to the invention allows simple assembly of functional elements on the shaft. To this end, the functional elements comprise a hole with a tooth arrangement which complements the tooth arrangement in the toothed portion. Therefore, the functional element can be pushed onto the toothed portion of the toothed shaft and, as a result of the capacity for positive-locking connection, a rotation of the functional element counter to the shaft is already prevented. As a result of the changed geometry of the tooth arrangement in the assembly portion, the functional element can now be pressed on the assembly portion. A durable, secure connection between the functional element and the shaft is thereby achieved with an optimum level of rotation prevention. No additional components are needed to fix the functional element. Similarly, no complex pretreatment of the shaft and the functional element is necessary with the proposed toothed shaft. Since toothed shafts are readily available as standard components, with the invention a toothed shaft with fixed components which can be configured flexibly and which is cost-effective can be provided. Here, the toothed shaft per se is claimed. In a preferred embodiment according to the dependent claims, the arrangement of a functional element on the toothed shaft is also claimed.

In one embodiment, a flank angle of the tooth arrangements is greater in the assembly portion than the flank angle in the toothed portion. A functional element can thereby be pressed into the tooth flanks. Therefore, the strength of the connection is further increased.

In another embodiment, a functional element having a hole which is toothed in a manner complementing the tooth arrangements of the toothed portion of the toothed shaft is pressed on the assembly portion of the toothed shaft. Consequently, any functional shafts can be provided with the toothed shaft according to the invention. Preferably, the functional element is formed by a cam or a sensor ring.

In another preferred embodiment, the toothed shaft has a plurality of toothed portions with adjoining assembly portions for fixing a plurality of functional elements. The flexibility during positioning of the functional elements is thereby further increased.

In the context of the invention, a method for producing a toothed shaft is further set out. The method according to the invention comprises the following steps:
providing a toothed shaft having at least one toothed portion, in which there are formed on the cover of the toothed shaft tooth arrangements which extend parallel with a rotation axis of the toothed shaft;
rolling on at least one part-portion of the at least one toothed portion transversely to the axial direction of the toothed shaft in order to produce at least one assembly portion.

The method according to the invention provides for a simple way of producing a toothed shaft for connection to functional elements. Only one operating step is necessary in order to produce the assembly portions on the toothed shaft. The processing method used is simple to carry out and is not greatly time-consuming or costly. The rolling machine required is usually already available. The position of the assembly portion can further be freely determined so that there are no restrictions in configuring the shaft.

The term “rolling” is intended to be understood to be a non-cutting cold-shaping method in which the surface profile of the toothed shaft present is plastically deformed. A rolling tool with a plurality of blades is pressed against the rotating toothed shaft perpendicularly to the covering face of the toothed shaft. The force is selected in such a manner that the rolling tool does not operate in a cutting manner but instead simply deforms the material. In this case, a material flow from the teeth between the blades and between the tooth flanks takes place.

Preferably, a tooth thickness of the tooth arrangements in the at least one assembly portion is increased by the rolling. This allows functional elements to be pressed into the tooth flanks of the assembly portion and improves the connection between the shaft and the functional element.

More preferably, a root circle diameter of the tooth arrangements in the at least one assembly portion is increased by the rolling. Thus, the functional element can be pressed on the assembly portion.

It is further preferable for a tip circle diameter of the tooth arrangements in the at least one assembly portion to be increased by the rolling. Thus, the functional element can be pressed on the assembly portion.

Furthermore, it is preferable for a material flow from tooth arrangements between the tooth flanks of the tooth arrangement in the at least one assembly portion to be brought about by the rolling.

In the context of the invention, a method for producing a functional shaft is further set out. The method according to the invention comprises the following steps:
providing a toothed shaft;
pushing on at least one functional element, in particular a cam or a sensor ring, having a hole which is toothed in a manner complementing the tooth arrangements of the toothed portion of the toothed shaft, on at least one toothed portion of the toothed shaft;
pressing the at least one functional element on the at least one assembly portion.

The functional shaft formed in this manner can be produced simply and in a cost-effective manner in a small number of operating steps, can be configured in a flexible manner as a result of the free ability to position the assembly portions on the toothed shaft and has a high level of rotation prevention of the pressed-on functional elements counter to the toothed shaft.

The invention will also be described below with reference to additional features and advantages and embodiments which are explained in greater detail with reference to the illustrations.

In the drawings:

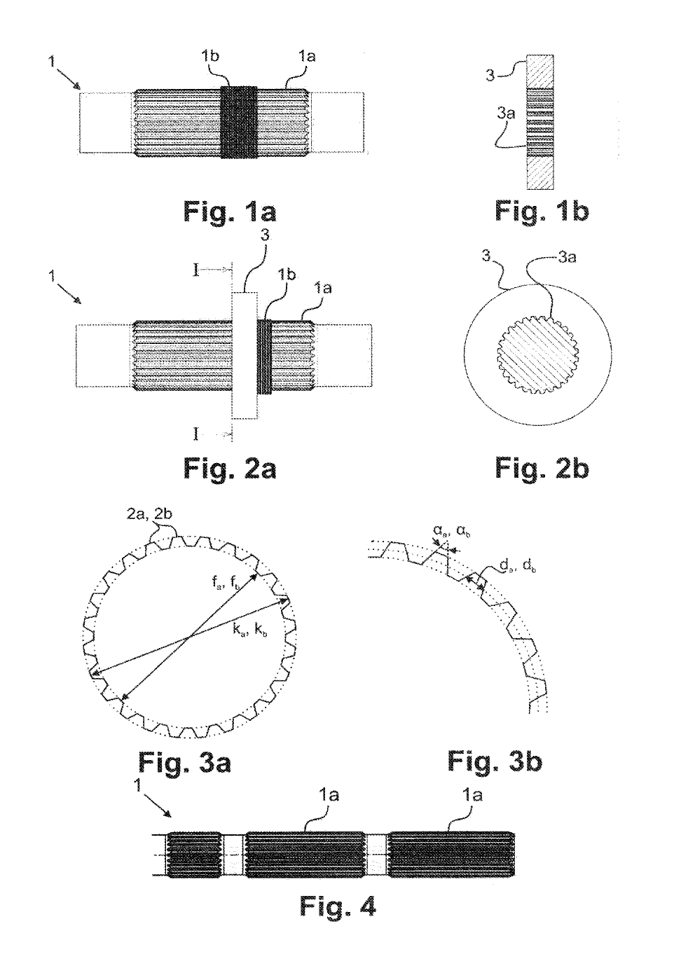

FIG. 1a shows a toothed shaft according to an embodiment of the present invention with an assembly portion;

FIG. 1b is a section of a functional element for fitting to the toothed shaft in FIG. 1a;

FIG. 2a shows the toothed shaft from FIG. 1a with a fitted functional element;

FIG. 2b is a section along the line I-I in FIG. 2a;

FIG. 3a is a cross-section through a toothed portion of the toothed shaft from FIG. 1a in order to explain relevant geometric variables of the tooth arrangement;

FIG. 3b is a detailed view of the cross-section from FIG. 3a;

FIG. 4 shows a toothed shaft according to another embodiment of the invention with a plurality of toothed portions.

FIG. 1a shows a toothed shaft 1 according to an embodiment of the present invention. The toothed shaft 1 has a toothed portion 1a in which tooth arrangements 2a are formed on the cover of the toothed shaft 1 and which extend parallel with the rotation axis of the toothed shaft 1. An assembly portion 1b which is described below adjoins the toothed portion 1a.

FIG. 1b is a section of a functional element 3 which can be pushed on the toothed shaft 1. To this end, the functional element 3 has a hole 3a which is formed so as to complement the tooth arrangement 1b of the toothed portion 1a of the toothed shaft 1. Thus, the functional element 3 can be pushed on the toothed shaft 1 in a rotationally secure manner. The functional element 3 is formed in the present embodiment, for example, by a cam or a senor ring.

In FIG. 2a, the functional element 3 is pushed on the toothed shaft 1. In this case, the functional element 3 is already pushed into the assembly portion 1b. As FIG. 1a shows, the assembly portion 1b also has tooth arrangements 2b. The tooth arrangements 2b correspond in terms of number and radial position to the tooth arrangements 2a in the toothed portion 1a. This can be seen in FIG. 2b which is a cross-section along the line I-I in FIG. 2a. Consequently, it is possible to push the functional element 3 from the toothed portion 1a into the assembly portion 1b. However, the shape of the tooth arrangements 2b differs in the assembly portion 1b from the shape of the tooth arrangements 2a in the toothed portion 1a.

FIG. 3a is a cross-section of the toothed shaft in order to define the relevant geometry parameters of the tooth arrangements 2a, 2b. The subscript “a” indicates geometry parameters of the toothed portion 1a, the subscript “b” indicates geometry parameters of the assembly portion 1b. The root circle diameter of the tooth arrangements 2a and 2b is designated fₐ and f_{b} and the tip circle diameter of the tooth arrangements 2a and 2b is designated kₐ and k_{b}.

FIG. 3b is a detailed view of the tooth arrangements 2a and 2b. The tooth thickness dₐ, d_{b} is defined at half of the height of the tooth arrangements 2a, 2b. Furthermore, the flank angle aₐ, a_{b} of the tooth arrangements 2a, 2b is indicated.

In order to produce the shown toothed shaft 1, a toothed shaft 1 is provided having a toothed region 1a and is rolled on a part-region of the toothed arrangement 2a in order to produce the assembly portion 1b. A cold-shaping of the tooth arrangement 2b in the assembly portion 1b is produced by the rolling. If a rolling tool with a plurality of blades is used, material of the tooth arrangement is pressed locally between the blades. In these regions, therefore, the tip circle diameter k_{b} in the assembly portion 1b is increased relative to the tip circle diameter kₐ of the toothed region 1a. Furthermore, material flows between the tooth flanks of the tooth arrangement 1b as a result of the rolling. The root circle diameter f_{b} is thereby increased locally relative to the root circle diameter fₐ of the toothed region 1a.

The pressing force of the rolling tool against the toothed shaft can be selected so that the tooth thickness d_{b} in the assembly portion is further increased relative to the tooth thickness dₐ in the toothed portion. Similarly, the flank angle a_{b} can be increased with respect to the flank angle aₐ as a result of the rolling.

As a result of the changed geometry of the tooth arrangement 2b in the assembly portion 1b, the functional element 3 whose hole 3a is positive-locking with respect to the tooth arrangement 1a can be pressed on the assembly portion 1b. If the tooth thickness d_{b} and/or the flank angle a_{b} is/are increased in the assembly portion 1b, the functional element is pressed into the flanks of the tooth arrangement 2b. The hole 3a which is formed so as to complement the tooth arrangement 1a already ensures that the functional element 3 cannot be rotated counter to the toothed shaft 1. As a result of the pressing on and/or in the assembly portion 1b, the functional element 3 is finally fixed on the toothed shaft 1. The connection which is formed in this manner is extremely stable and can be formed without complex processing methods or additional elements.

FIG. 4 shows an alternative embodiment of the toothed shaft 1 before the production of assembly portions 1b. The toothed shaft 1 shown in FIG. 4 has a plurality of toothed portions 1a. Thus, a plurality of assembly portions 1b can be produced by rolling on the respective toothed portions 1a.

It is naturally possible with the method described to produce a plurality of assembly portions 1b in a toothed region 1a. Thus, the position of the functional elements 3 on the toothed shaft 1 can be freely determined.

Different functional shafts can be produced with the toothed shafts 1 described by rolling and subsequent pressing of functional elements 3. In particular, robust camshafts can be produced if cams are used as functional elements 3. Additional functional elements 3, such as sensor rings, can be fixed on the camshaft. The precise arrangement of the functional elements 3 can in this case be determined directly before assembly by rolling being carried out selectively at the corresponding positions on the toothed shaft 1. Generally, the production of any functional shafts is thus allowed with a high level of stability of the fixed functional elements 3 in a cost-effective manner with little complexity.

Furthermore, a rolling tool which comprises one or more smooth rollers can be used to produce the assembly portion 1b. With such a rolling tool, it is also possible to achieve a material flow between the tooth flanks in the assembly portion 1b by means of cold-shaping, wherein the geometry of the tooth arrangement 2b is changed so that a functional element 3 can be fixed in the assembly portion 1b as described above.

1-11. (canceled).

12. A toothed shaft, comprising:
a cover,
a toothed portion, in which tooth arrangements are formed on the cover that extend parallel with a rotation axis of the toothed shaft,
an assembly portion having tooth arrangements adjoining the toothed portion, wherein the number and the radial position of the tooth arrangements in the assembly portion correspond to the number and the radial position of the tooth arrangements in the toothed portion, and
wherein at least one tooth thickness of the tooth arrangements is greater in the assembly portion than a tooth thickness in the toothed portion, or
at least one root circle diameter of the tooth arrangements in the assembly portion is greater than a root circle diameter in the toothed portion, or
at least one tip circle diameter of the tooth arrangements in the assembly portion is greater than a tip circle diameter in the toothed portion.

13. The toothed shaft of claim 12, wherein a flank angle of the tooth arrangements is greater in the assembly portion than a flank angle in the toothed portion.

14. The toothed shaft of claim 12, wherein a functional element having a hole which is toothed in a manner complementing the tooth arrangements of the toothed portion of the toothed shaft is pressed on the assembly portion of the toothed shaft.

15. The toothed shaft of claim 14, wherein the functional element is formed by a cam or a sensor ring.

16. The toothed shaft of claim 12, wherein the toothed shaft has a plurality of toothed portions with adjoining assembly portions configured to fix a plurality of functional elements.

17. A method for producing the toothed shaft of claim 12, comprising:
providing a toothed shaft having at least one toothed portion, in which there are formed on the cover of the toothed shaft tooth arrangements which extend parallel with a rotation axis of the toothed shaft;
rolling on at least one part-portion of the at least one toothed portion transversely to the axial direction of the toothed shaft in order to produce at least one assembly portion.

18. The method of claim 17, wherein a tooth thickness of the tooth arrangements in the at least one assembly portion is increased by the rolling.

19. The method of claim 17, wherein a root circle diameter of the tooth arrangements in the at least one assembly portion is increased by the rolling.

20. The method of claim 17, wherein a tip circle diameter of the tooth arrangements in the at least one assembly portion is increased by the rolling.

21. The method of claim 17, wherein a material flow from tooth arrangements between the tooth flanks of the tooth arrangement in the at least one assembly portion is brought about by the rolling.

22. A method for producing a functional shaft, using the toothed shaft of claim 12, comprising:
providing a toothed shaft as claimed in claim 12;
pushing on at least one functional element having a hole which is toothed in a manner complementing the tooth arrangements of the toothed portion of the toothed shaft, on at least one toothed portion of the toothed shaft; and
pressing the at least one functional element on the at least one assembly portion.
